(19) United States
(12) Patent Application Publication
(10) Pub. No.: US 2018/0253670 A1
(43) Pub. Date: Sep. 6, 2018

(54) SYSTEM TO PROCESS DATA ALLOCATING RESOURCE AVAILABILITY RISK

(71) Applicants: Catherine M. Sommer, West Hartford, CT (US); Barkley Scott Harris, Prospect, CT (US)

(72) Inventors: Catherine M. Sommer, West Hartford, CT (US); Barkley Scott Harris, Prospect, CT (US)

(21) Appl. No.: 15/451,014

(22) Filed: Mar. 6, 2017

(51) Int. Cl. G06Q 10/06; G06Q 40/08

(52) U.S. Cl. CPC G06Q 10/0635; G06Q 40/08

(57) ABSTRACT

According to some embodiments, a resource interruption data store may contain data records each associated with an unexpected resource interruption having a resource identifier, a notification indication, and data defining a period of time that the resource is not available to an enterprise. A resource impact data store may contain data records each associated with an enterprise impact and including a resource identifier, an impact value reflecting a magnitude of the impact, and supplemental information associated with the enterprise impact. A back-end application computer server may receive a request from a remote user terminal and apply logic to automatically identify a period of time that a particular resource is unexpectedly not available to the enterprise based on a waiting period and the notification indication. The server may then calculate an overall amount associated with the enterprise and transmit the overall amount to the remote user terminal.

### FIELD

The present invention relates to computer systems and, more particularly, to computer systems to process data allocating risk associated with resource availability for an enterprise.

### BACKGROUND

An enterprise may utilize various types of resources during normal day-to-day operation. For example, an enterprise might utilize computer processing power (e.g., either locally or in a cloud-based architecture), employees, etc. to analyze and interpret substantial amounts of data. In some case, portions of the resources utilized by the enterprise may become unavailable (e.g., due to hardware failures, software errors, employees being absent, etc.). As a result, the ability of the enterprise to operate normally may be impaired. This type of situation could, for example, lead to delays, missed opportunities, costly work-around solutions, etc. In view of these considerations, improved ways to facilitate allocation of resource interruption risk for an enterprise may be desired.

### SUMMARY

According to some embodiments, systems, methods, apparatus, computer program code and means may process data to allocate resource interruption risk for an enterprise. In some embodiments, resource interruption data store may contain data records each associated with an unexpected resource interruption having a resource identifier, a notification indication, and data defining a period of time that the resource is not available to an enterprise. A resource impact data store may contain data records each associated with an enterprise impact and including a resource identifier, an impact value reflecting a magnitude of the impact, and supplemental information associated with the enterprise impact. A back-end application computer server may receive a request from a remote user terminal and apply logic to automatically identify a period of time that a particular resource is unexpectedly not available to the enterprise. The server may then calculate an overall amount associated with the enterprise and transmit the overall amount to the remote user terminal.

Some embodiments provide: means for accessing, by the back-end application computer server, a resource interruption data store containing electronic data records associated with the enterprise, each electronic data record being associated with an unexpected resource interruption having a resource identifier, a notification indication, and data defining a period of time that the resource is not available to the enterprise; means for accessing, by the back-end application computer server, a resource impact data store containing electronic data records associated with the enterprise, each electronic data record being associated with an enterprise impact and including a resource identifier, an impact value reflecting a magnitude of the impact to the enterprise, and supplemental information associated with the enterprise impact; responsive to a request received from a remote user terminal via a distributed communication network, means for applying logic to automatically identify a period of time that a particular resource, associated with a particular resource identifier, is unexpectedly not available to the enterprise, the identification being based at least in part on a waiting period and the notification indication associated with the particular resource identifier; means for calculating an overall amount associated with the enterprise based at least in part on the automatically identified period of time, the supplemental information, and the impact value associated with the particular resource identifier along with a pre-defined threshold associated with the enterprise; and means for transmitting, via the distributed communication network, information associated with the calculated overall amount to the remote user terminal that generated the request.

A technical effect of some embodiments of the invention is an improved, secure, and computerized method to facilitate allocation of resource interruption risk for an enterprise. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method that might be performed in accordance with some embodiments.

FIG. 3A is an example of various resource time periods according to some embodiments.

FIG. 3B illustrates a claim submission display that might be provided in accordance with some embodiments.

FIG. 4 is a more detailed hardware diagram of a system according to some embodiments.

FIG. 5 illustrates an essential personnel method that might be implemented according to some embodiments.

FIG. 6 illustrates end results of a frequency methodology in accordance with some embodiments.

FIG. 7 shows premium examples for business income and extra expenses for essential personnel according to some embodiments.

FIG. 8 is block diagram of a back-end application tool or platform according to some embodiments of the present invention.

FIG. 9 is a tabular portion of a resource database according to some embodiments.

FIG. 10 is a tabular portion of a resource interruption database according to some embodiments.

FIG. 11 is a tabular portion of a resource impact database according to some embodiments.

FIG. 12 illustrates an interactive operator display on a portable device in accordance with some embodiments.

FIG. 13 illustrates an overall enterprise method that might be performed in accordance with some embodiments.

### DETAILED DESCRIPTION

The present invention provides significant technical improvements to facilitate allocation of resource interruption risk for an enterprise. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the areas of resource utilization by providing benefits in data accuracy, data availability, and data integrity, and such advances are not merely a longstanding commercial practice. The present invention provides improvement beyond a mere generic computer implementation as it involves the processing and conversion of significant amounts of data in a new beneficial manner as well as the interaction of a variety of specialized client and/or third party systems, networks and subsystems. For example, in the present invention information may be processed, forecast, and/or predicted via a back-end application computer server and results may then be analyzed efficiently to evaluate appropriate risk scenarios and/or amounts, thus improving the overall performance of an enterprise system, including message storage requirements and/or bandwidth considerations (e.g., by reducing a number of messages associated with risk allocation and/or resource utilization that need to be transmitted via a network). Moreover, in some embodiments a list of resources (e.g., employees of a business) might not need to be maintained when a risk relationship is initially established. Instead, details about resources might only be required when the availability of a resource becomes unexpectedly interrupted. In this way, the amount of data that needs to be stored, updated, verified and/or processed by the system may be greatly reduced.

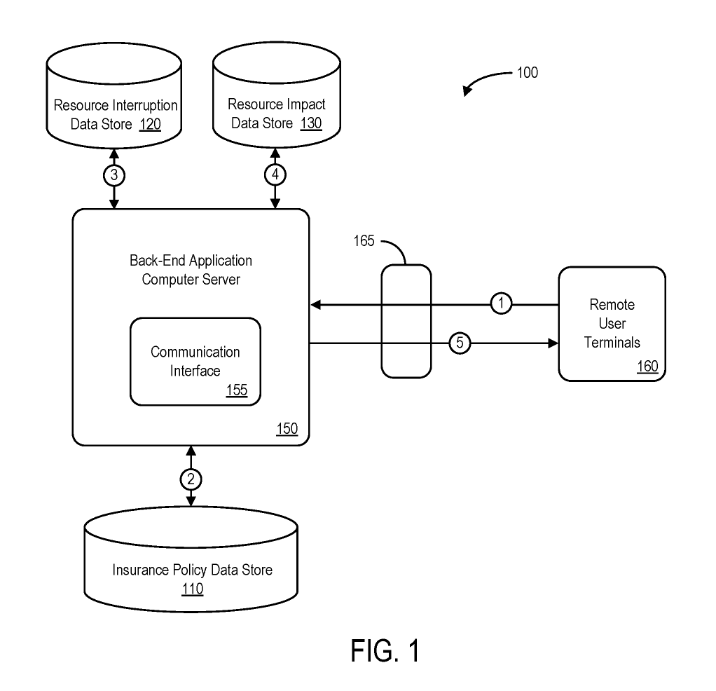

An enterprise may utilize various types of resources during normal day-to-day operation. For example, an enterprise might utilize computer processing power (e.g., either locally or in a cloud-based architecture), employees, etc. to analyze and interpret substantial amounts of data. In some case, portions of the resources utilized by the enterprise may become unavailable (e.g., due to hardware failures, software errors, employees being absent, etc.). As a result, the ability of the enterprise to operate normally may be impaired. This type of situation could, for example, lead to delays, missed opportunities, costly work-around solutions, etc. In view of these considerations, improved ways to facilitate allocation of resource interruption risk for an enterprise may be desired. FIG. 1 is a high-level block diagram of a system 100 according to some embodiments of the present invention. In particular, the system 100 includes a back-end application computer server 150 that may access information in an insurance policy data store 110 (e.g., storing a set of electronic records representing risk relationships between an insurer and an enterprise including an insurance policy identifier). The back-end application computer server 150 may also exchange information with remote user terminals 160 (e.g., via a firewall 165). According to some embodiments, a communication interface 155 of the back-end application computer server 150 may communicate with the remote user terminals 160 and access information in the insurance policy data store 110. Note that embodiments may be associated with periodic (or asynchronous) types of uploads and/or downloads. Further note that the back-end application computer server 150 might also be associated with a third party, such as a vendor that performs a service for an enterprise.

The back-end application computer server 150 might be, for example, associated with a Personal Computer (“PC”), laptop computer, smartphone, an enterprise server, a server farm, and/or a database or similar storage devices. According to some embodiments, an “automated” back-end application computer server 150 may automatically access and/or process changes to information in the insurance policy data store 110. As used herein, the term “automated” may refer to, for example, actions that can be performed with little (or no) intervention by a human.

As used herein, devices, including those associated with the back-end application computer server 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the insurance policy data store 110, a resource interruption data store 120 (e.g., storing information about resource interruptions or lack of availability including a resource identifier, notification indication, a period of time the resource is unavailable, etc.), and/or a resource impact data store 130 (e.g., storing information about an enterprise impact including a resource identifier and an impact value). The insurance policy data store 110 and other data sources described herein may be locally stored or reside remote from the back-end application computer server 150. As will be described further below, the insurance policy data store 110 may be used by the back-end application computer server 150 to automatically process resource interruption information. Although a single back-end application computer server 150 is shown in FIG. 1, any number of such devices may be included. Moreover, various devices described herein might be combined according to embodiments of the present invention. For example, in some embodiments, the back-end application computer server 150, insurance policy data store 110, resource interruption data store 120, and/or resource impact data store 130 might be co-located and/or may comprise a single apparatus.

According to some embodiments, the system 100 may automatically process resource interruption information for an enterprise. For example, at (1) at remote user terminal 160 may transmit a request to the back-end application computer server 150 (e.g., via communication interface 155). The back-end application computer server 150 may then access information in the insurance policy data store at (2), the resource interruption data store at (3), and/or the resource impact data store at (4). The back-end application computer server 150 may then process resource interruption information as appropriate and transmit an update to the remote user terminal 160 at (5).

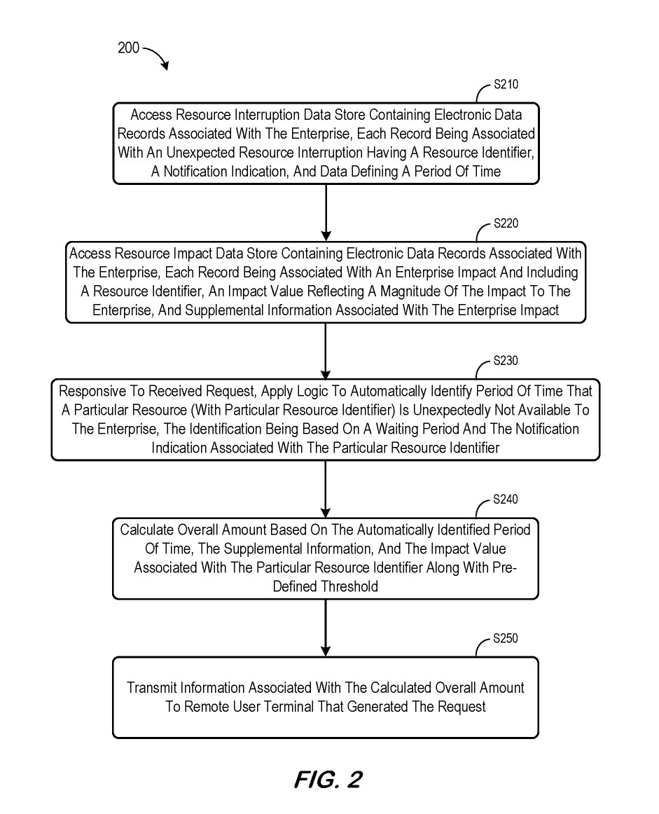

Thus, some embodiments may facilitate allocation of resource interruption risk for an enterprise. Note that the system 100 of FIG. 1 is provided only as an example, and embodiments may be associated with additional elements or components. According to some embodiments, the elements of the system 100 automatically support interactive user interface displays over a distributed communication network. For example, FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a back-end application computer server may access a resource interruption data store. The resource interruption data store may contain, for example, electronic data records associated with the enterprise, each electronic data record being associated with an unexpected resource interruption having a resource identifier, a notification indication, and data defining a period of time that the resource is not available to the enterprise. At S220, the back-end application computer server may access a resource impact data store. The resource impact data store may contain electronic data records associated with the enterprise, each electronic data record being associated with an enterprise impact and including a resource identifier, an impact value reflecting a magnitude of the impact to the enterprise, and supplemental information associated with the enterprise impact (e.g., representing evidence documenting the interruption and/or the magnitude of the impact).

At S230, a request may be received from a remote user terminal via a distributed communication network. Responsive to the request, the system may apply logic to automatically identify a period of time that a particular resource (associated with a particular resource identifier) is unexpectedly not available to the enterprise. Note that the identification may be based at least in part on a waiting period (e.g., a thirty day waiting period) and the notification indication associated with the particular resource identifier. At S240, the system may calculate an overall amount associated with the enterprise based at least in part on the automatically identified period of time, the supplemental information, and the impact value associated with the particular resource identifier. The overall amount may also be based on, according to some embodiments, a pre-defined threshold associated with the enterprise (e.g., representing a maximum value of the overall amount). At S250, the system may transmit, via the distributed communication network, information associated with the calculated overall amount to the remote user terminal that generated the request.

According to some embodiments, a risk relationship may be established with the enterprise in exchange for receiving a payment. For example, the enterprise might comprise a business, the risk relationship might be an insurance policy, and the payment might be associated with an insurance premium. In this case, the back-end application computer server (or any other device) may further calculate an appropriate insurance premium for the insurance policy. As will be described, the appropriate insurance premium might be based on, for example, at least four of: a coverage limit, a number of employees, a business sales amount, an industry category, a frequency component, a severity component, a permissible component, a base rate, a size curve, disability claim history (e.g., short and/or long term disability claim histories), workers' compensation claim history, a frequency distribution, a correlation of risk, and at least one loss mitigation factor. According to some embodiments, an appropriate insurance premium might be based at least in part on a mortality rate. Note, however, that embodiments described herein differ from a typical life insurance policy that a business might purchase for “key” employees (e.g., at least because of the other protections that are provided to the business).

Note that an enterprise, such as a business, may be concerned about cash flow (and related issues) when a particularly important employee is suddenly and unexpectedly absent from work. For example, if a top salesperson is unable to work for an extended period of time, the impact to the business could be substantial. This might be especially true for relatively small businesses (e.g., because the absence of even a single employee might cause serious cash flow issues). According to some embodiments, an optional property insurance endorsement may cover lost business income and/or extra expenses in such situations. While products such as “key personnel life insurance” exist to pay a benefit to a business upon the death of a key person, such policies do not protect the business when an employee is unavailable for other reasons.

As used herein, the phrase “essential personnel” might refer to, for example, any full-time, W-2 employee (other than an owner of a sole proprietorship) whose absence has a material impact on business operations. According to some embodiments, there may not be a reason to pre-identify essential personnel (and, as a result, all resources in a resource data store might have a resource importance flag designating them as essential). That is, all full-time employees who are not owners of a sole proprietorship may be considered essential personnel (in some cases, independent contractors and/or part-time employees may be excluded). Coverage may be associated with a maximum period of time (e.g., 90 days) after which it may be assumed that the business will be able to make accommodations for the missing employee.

According to some embodiments, coverage may be triggered by sudden and unexpected absences (including permanent and temporary absences) and any applicable waiting period (e.g., a thirty day waiting period). For example, an essential personally might need to be absent for 30 or more consecutive days to trigger coverage. Moreover, insurance policies may be associated with an overall coverage limit (e.g., a maximum of $50,000 of combined lost business income and extra expenses might be covered). Note that some situations could be excluded from coverage in some embodiments (e.g., termination, resignation, retirement, vacation, etc.). Similarly, notification of an absence more than 30 days in advance might prevent coverage (because the employer had sufficient time to hire another employee or take other steps to avoid damages). As other examples, coverage limits might be capped at 50% of sales, new ventures may be excluded, etc.

In some cases, underwriting decisions (including calculation of a premium amount) may consider whether or not there a documented business plan addressing how an enterprise will respond in event of an essential person's absence. Other considerations might include: an existing relationship with a recruiter service or vendor partners who can help fill key needs/functions promptly; a redundancy of essential skills and functions knowledge across an employee base such that critical functions can be performed by multiple people; and/or documented processes and procedures for key business functions and services to enable others to perform business operations in event of an absence of a primary responsible person.

Note that covered claims for essential personnel may often be medically driven. However, because parties (including claim adjusters) may not have training in Health Insurance Portability and Accountability Act (“HIPAA”) guidelines and may not be able to interpret medical records, requesting medical documents may be inappropriate. Other types of information that might be used to validate a claim (and that might be stored in the resource impact data store 130) could include: sworn statements by an insured and/or other employees (notarized); payroll records showing the employee hasn't been paid; timekeeping records showing the employee hasn't been at work; workers' compensation or disability claim payment information; correspondence between the insured and the employee showing absence dates; news reports about an employee if the absence was due to an automobile accident or some other public occurrence; and/or an obituary for a deceased employee.

By way of example, consider an employee who tells the insured on June 1 that he has just been diagnosed with a medical problem and will be out of the office starting from June 2 through September 1 to treat the condition. As a result, the employer is forced to pay the remaining employees overtime to make up for the missed work. In this case, the incurred extra overtime expense will be covered from June 1 through September 1 (or whenever the EP returns). As another example, an insured's top salesperson tells the insured on June 1 that she will be taking an extended honeymoon. She will be gone from August 1 through September 15 and, as a result, the employer loses income while that salesperson is out of the office. In this example, the lost business income will not be covered because the insured was given notice of the absence more than thirty days in advance.

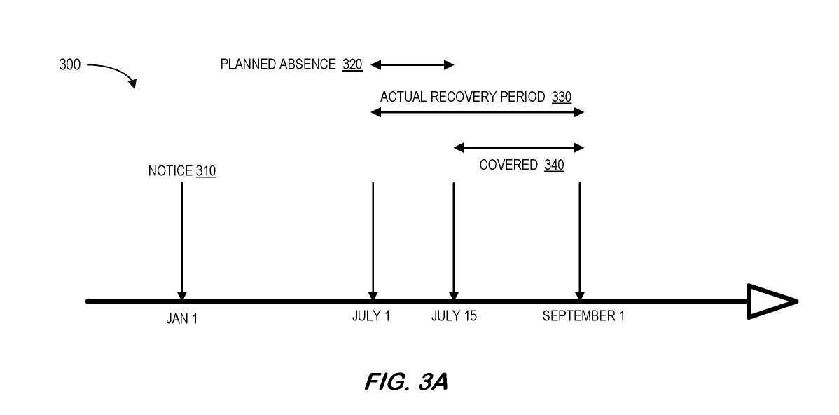

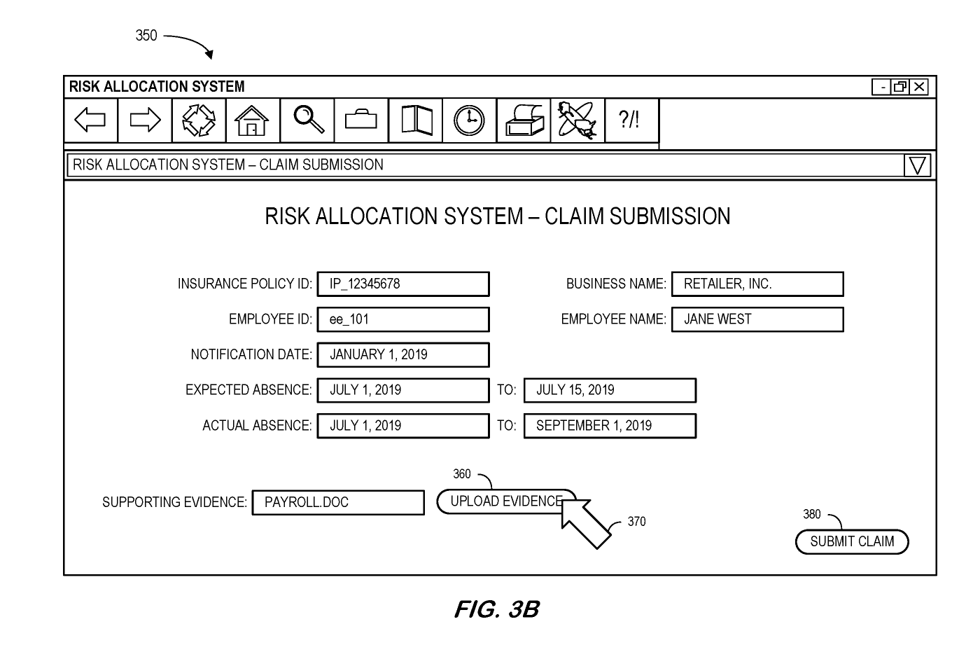

FIG. 3A is another example 300 of various resource time periods accordance with some embodiments. In this example, an insured's office administrator had notified 310 his employer on January 1 about a planned absence 320 for cosmetic surgery from July 1 through July 15. However, during the procedure, there was an emergency and now the administrator will be out of the office during a recovery period 330 until September 1. As a result, the insured is forced to hire a temporary employee to run the office while the administrator is out. In this example, the incurred extra expense will be covered 340 from July 16 through September 1. The period of restoration begins on July 16 because that is when the employee's absence became unexpected. The period of time from July 1 through July 15 was known about more than thirty days in advance and, therefore, wasn't sudden and unexpected.

FIG. 3B illustrates a claim submission display 350 that might be provided in accordance with some embodiment. The claim submission display 350 might be used, for example, by an insurance agent or business to submit an insurance claim to an insurer. The display 350 includes input areas to provide an insurance policy number, business name, employee identifier, employee name, etc. The display 350 may further include input areas to provide a notification date, an expected absence period of time, an actual absence period of time, etc. The display 350 may also be used to provide supporting evidence. For example, a file name might be entered into the system and the user might select an “Upload Evidence” icon 360 (e.g., via his or her computer mouse pointer 370) to transfer the data to the insurer. When all information has been entered, the agent or business might select a “Submit Claim” icon 380 to request that the insurer automatically calculate an appropriate time period of coverage and/or appropriate business income losses or extra expenses associated with the submitted claim.

As still another example, an employee of an insured unexpectedly gives his two week notice. He advises the insured that he will be leaving the company to go work for a competitor. The insured loses income until the employee is replaced. In this case, the lost business income might not be covered because the resignation of an essential employee is specifically excluded from the policy.

Note that embodiments described herein might be associated with many different types of insurance policies, endorsements, terms, conditions, extensions, etc. By way of example only, coverage might be provided for an actual loss of business income sustained due to a necessary suspension of “operations” during an “essential person period of restoration.” The suspension may be caused by an “essential person absence.” Coverage might also include reasonable and necessary extra expense incurred during the “essential person period of restoration” that would not have been incurred if there had been no “essential person absence.” The term “business income” might refer to, for example, net income (net profit or loss before income taxes) that would have been earned or incurred if no “essential person absence” had occurred and continuing normal operating expenses incurred, including payroll. The term “extra expense” might refer to, for example, expenses to avoid or minimize the suspension of business and to continue operations or to minimize the suspension of business operations cannot be continued (to the extent it reduces the amount of loss that otherwise would have been payable). Moreover, the term suspension might refer to a partial slowdown or complete cessation of business activities.

The phrase “essential person” might refer to, for example, any natural person, while a full-time employee, who is compensated directly by salary, wages or commissions and who the business has the right to direct and control. Note that the term “essential person” might not include an owner of a sole-proprietorship.

The phrase “essential person absence” might refer to, for example, a sudden and unexpected absence of an “essential person” from their position of employment for a time period of thirty consecutive days or more (and the absence might be either permanent or temporary). According to some embodiments, an “essential person absence” might not include any essential person who has been terminated (for any reason), any essential person who has voluntarily resigned or retired (for any reason), or any essential person′ absence that a business was made aware of more than thirty days in advance.

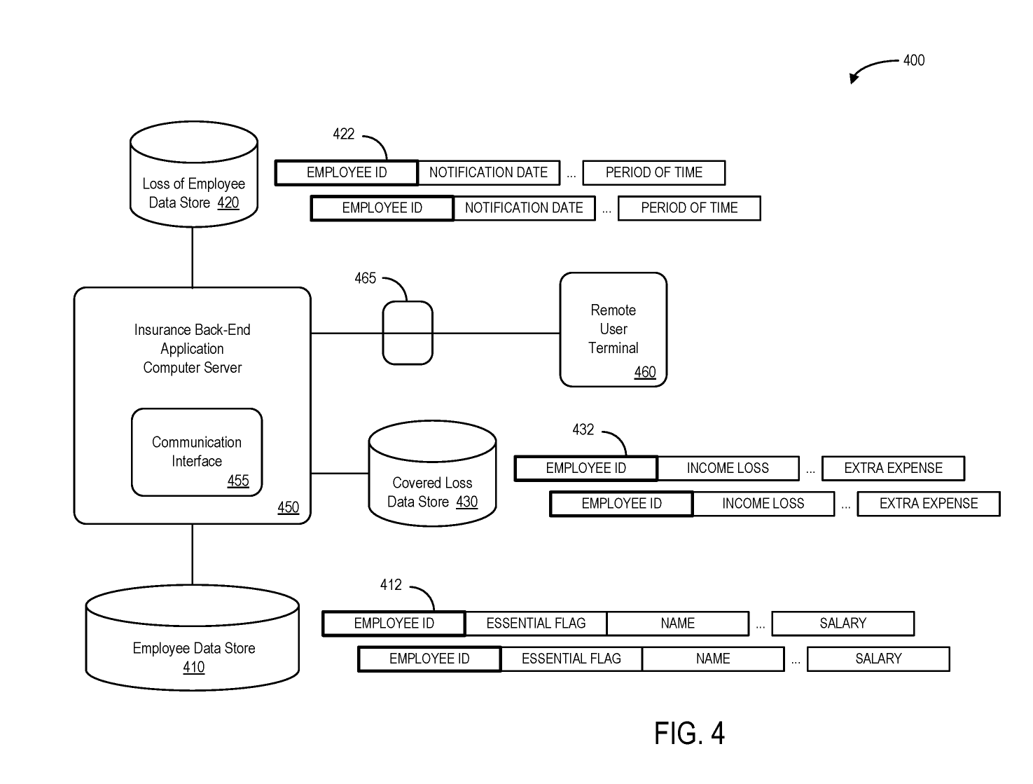

FIG. 4 is a more detailed hardware diagram of a system 400 according to some embodiments. As before, the system 400 includes an insurance back-end application computer server 450 that may access information in an employee data store 410 (e.g., storing a set of electronic records 412 representing an employee identifier, name, salary, etc.). The back-end application computer server 450 may also exchange information with remote user terminals 460 (e.g., via a firewall 465). According to some embodiments, a communication interface 455 of the back-end application computer server 450 may communicate with the remote user terminals 460 and access information in the employee data store 410.

The back-end application computer server 450 may store information into and/or retrieve information from the employee data store 410, a loss of employee data store 420 (e.g., storing information 422 about absent employees including an employee identifier, a notification date, a period of time the employee is unavailable, etc.), and/or a covered loss data store 430 (e.g., storing information 432 about an enterprise impact including an employee identifier, income loss data, extra expense data, etc.). The employee data store 410 and other data sources described herein may be locally stored or reside remote from the back-end application computer server 450. As will be described further below, the employee data store 410 may be used by the back-end application computer server 450 to automatically process essential personnel loss information. Although a single back-end application computer server 450 is shown in FIG. 4, any number of such devices may be included.

According to some embodiments, the covered loss data store 430 might further contain: data associated with a sworn statement, payroll record data, timekeeping records, workers' compensation or disability claim payment information, correspondence between the business and an employee, an indication of a news report associated with an employee, an indication of an obituary associated with an employee, and/or social media information associated with an employee.

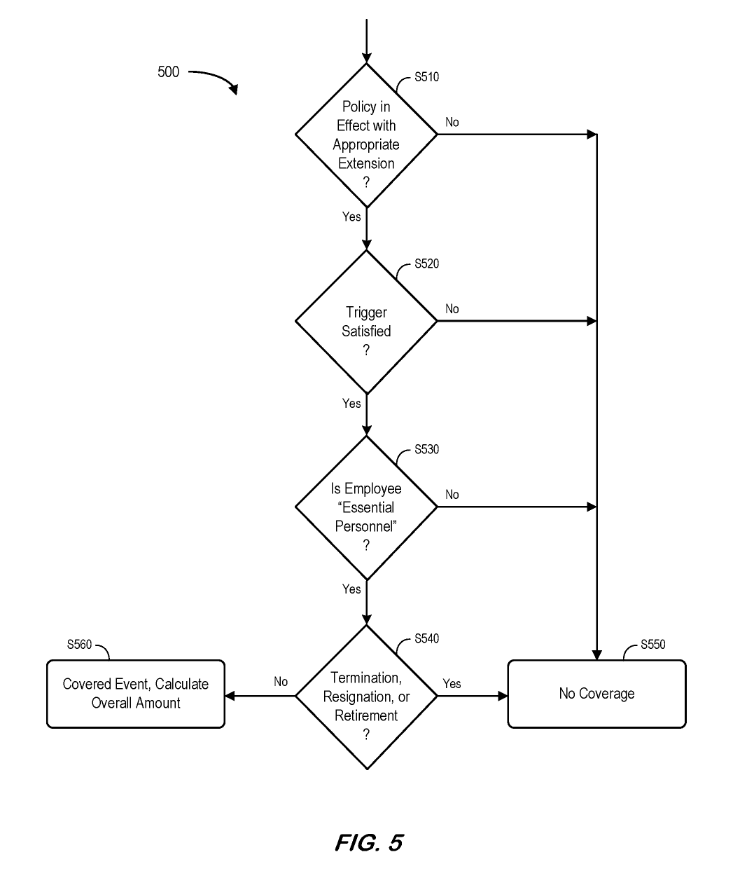

FIG. 5 illustrates an essential personnel method 500 that might be implemented according to some embodiments. At S510 it is determined if an insurance policy is effect with an appropriate “essential personnel” extension. If not, there is no coverage at S550. At S520 it is determined if a trigger condition is satisfied (was there a sudden, expected absence?). If not, there is no coverage at S550. At S530 it is determined if the employee is considered “essential personnel” (note that in some cases, all employees may be assumed to qualify as essential personnel). If not, there is no coverage at S550. At S540 it is determined if the absence is due to termination, resignation or retirement. If so, there is no coverage at S550. Otherwise, event qualifies for coverage at S560 and the system will calculate an overall amount of loss (e.g., lost business income and/or extra expenses).

According to some embodiments, an insurer may need to establish an appropriate premium for an insurance policy that covers essential personnel as described herein. In order to do so, considerations might include a frequency component, a severity component, and/or a permissible component. The frequency component might be based on, for example, death data, workers' compensation incidents, Short Term Disability (“STD”) data, Long Term Disability (“LTD”) data, Family Medical Leave Act (“FMLA”) data, etc. The system may attempt to estimate a percent of claims over thirty days in duration, and then a conditional value of how long a person will probably be out if the claim is covered. The severity component might consider: how much business income does a person contribute; when they are out suddenly, how long are they out, etc. The permissible component might be based on inputs to indications and/or simplified assumptions made about how amounts should be allocated for the expense incurred to tack on an optional coverage to an underlying policy.

Factors that may be considered when rating a product may include a base rate that varies by market group (low, medium, and high risk). The base rate might also consider an industries workers' compensation exposure, exposure to key person dependency, how quickly a replacement can be found, and an overall coverage limit. According to some embodiments, a size curve may have factors that vary by intersection of employee count and sales amount.

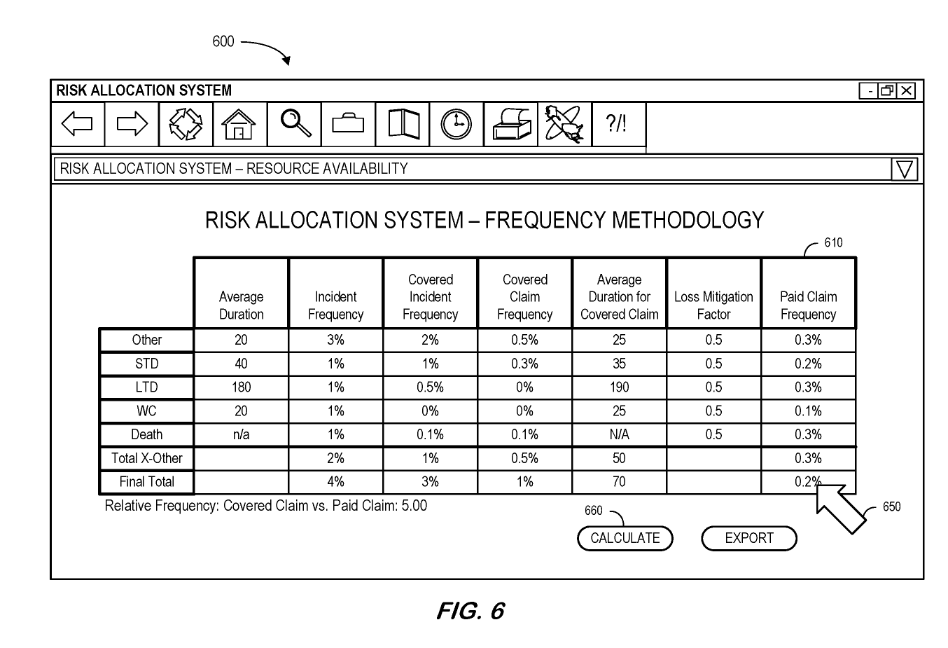

FIG. 6 illustrates end results 600 of a frequency methodology in accordance with some embodiments. In particular, the results 600 include data 610 for various types of absences (“other,” STD, LTD, workers' compensation, and death events). The data 610 represents an average duration, incident frequency, a covered incident frequency, a covered claim frequency, an average duration for a covered claim, a loss mitigation factor, and paid claim frequency. Note that selection of data 610 by a computer pointer 650 could result in a display of further details about the data (e.g., in a pop-up window), an adjustment to the data, etc. Moreover, selection of various icons 760 might result in data being calculated (or re-calculated), exported, printed, etc.

Note that most of the general frequency may be from “other” incidents—however, these events might be rarely covered since the have advance notice or are not long absences. The majority of paid claim frequency may come from people on STD, workers' compensation, or from employee death. According to some embodiments, the data 610 may be processed using a Service-Oriented Analysis (“SOA”) approach.

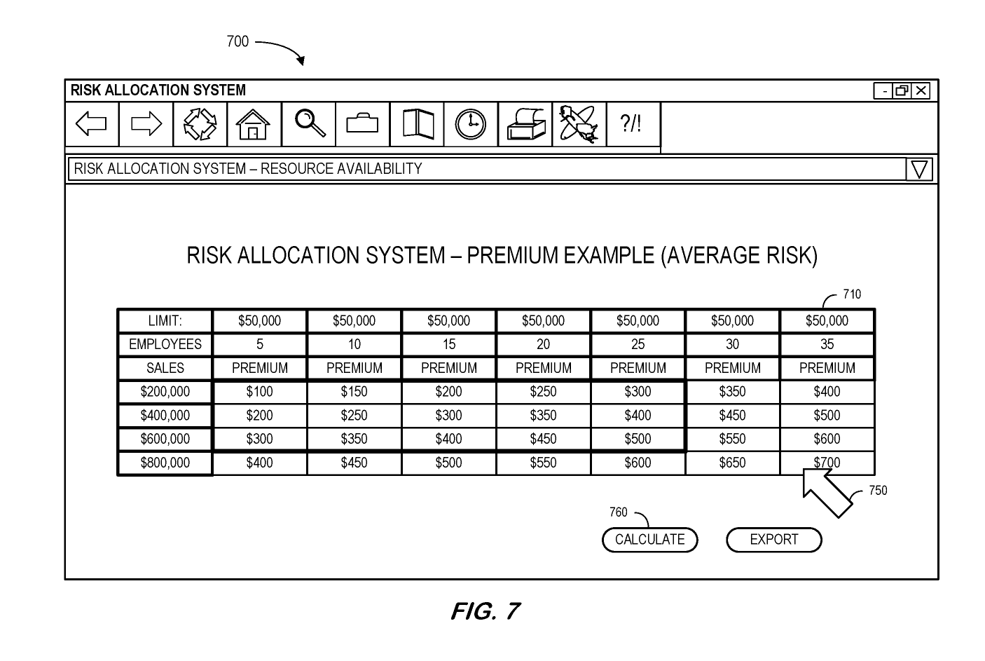

FIG. 7 shows premium examples 700 for business income and extra expenses for essential personnel according to some embodiments. In particular, data 710 is provided for an average risk business having a $50,000 coverage limit. Note that premiums increase both as the number of employees increases and as the amount of overall sales increases. Selection of data 710 by a computer pointer 750 could result in further details about the data, an adjustment to the data, etc. Moreover, selection of various icons 760 might result in data being calculated (or re-calculated), exported, printed, etc.

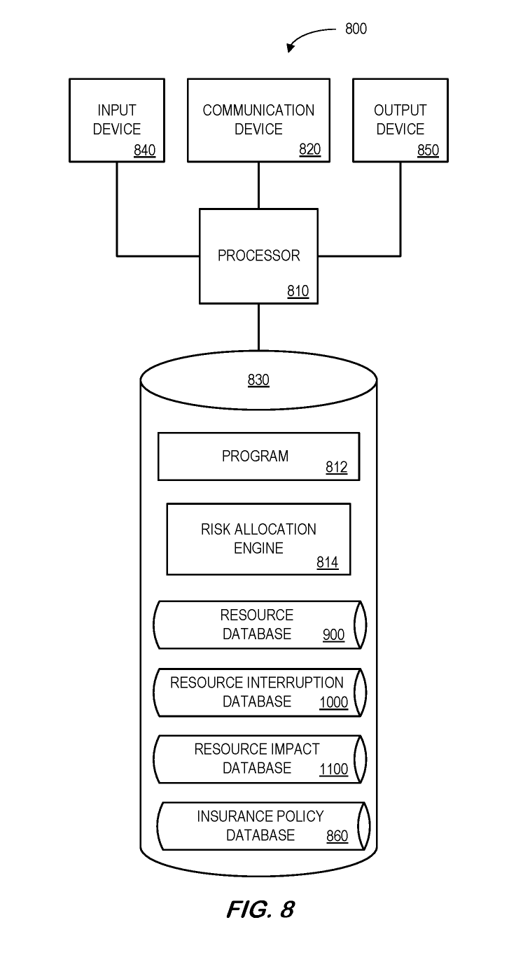

The embodiments described herein may be implemented using any number of different hardware configurations. For example, FIG. 8 illustrates back-end application computer server tool or platform 800 that may be, for example, associated with the systems 100, 400 of FIGS. 1 and 4, respectively. The platform 800 comprises a processor 810, such as one or more commercially available Central Processing Units (CPUs) in the form of one-chip microprocessors, coupled to a communication device 820 configured to communicate via a communication network (not shown in FIG. 8). The communication device 820 may be used to communicate, for example, with one or more remote user terminals, databases, etc. Note that communications exchanged via the communication device 820 may utilize security features, such as those between a public internet user and an internal network of the insurance enterprise. The security features might be associated with, for example, web servers, firewalls, and/or PCI infrastructure. The platform 800 further includes an input device 840 (e.g., a mouse and/or keyboard to enter information about essential personnel and/or businesses) and an output device 850 (e.g., to output reports regarding system administration, loss history data, insurance policy premiums, etc.).

The processor 810 also communicates with a storage device 830. The storage device 830 may comprise any appropriate information storage device, including combinations of magnetic storage devices (e.g., a hard disk drive), optical storage devices, mobile telephones, and/or semiconductor memory devices. The storage device 830 stores a program 88 and/or a risk allocation engine or application 814 for controlling the processor 810. The processor 810 performs instructions of the programs 812, 814, and thereby operates in accordance with any of the embodiments described herein. For example, the processor 810 may access a resource interruption data store containing data records each associated with an unexpected resource interruption having a resource identifier, a notification indication, and data defining a period of time that the resource is not available to an enterprise. The processor 810 may also access a resource impact data store containing data records each associated with an enterprise impact and including a resource identifier, an impact value reflecting a magnitude of the impact, and supplemental information associated with the enterprise impact. The processor 810 may receive a request from a remote user terminal and automatically apply logic to identify a period of time that a particular resource is unexpectedly not available to the enterprise. The processor 810 may then calculate an overall amount associated with the enterprise and transmit the overall amount to the remote user terminal.

The programs 88, 814 may be stored in a compressed, uncompiled and/or encrypted format. The programs 88, 814 may furthermore include other program elements, such as an operating system, a database management system, and/or device drivers used by the processor 810 to interface with peripheral devices.

As used herein, information may be “received” by or “transmitted” to, for example: (i) the platform 800 from another device; or (ii) a software application or module within the platform 810 from another software application, module, or any other source.

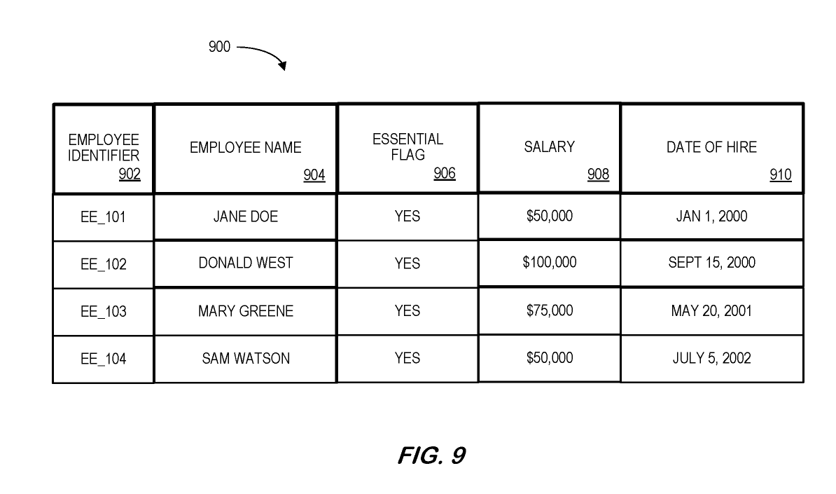

In some embodiments (such as shown in FIG. 8), the storage device 830 includes a resource database 900, a resource interruption database 1000, a resource impact database 1100, and an insurance policy database 860 (e.g., storing details about insurance policy coverage, premiums, business data, etc.). Examples of databases that may be used in connection with the platform 800 will now be described in detail with respect to FIGS. 9 through 11. Note that the databases described herein are only examples, and additional and/or different information may be stored therein. Moreover, various databases might be split or combined in accordance with any of the embodiments described herein. For example, the insurance policy database 860 might be combined and/or linked to each other within the risk allocation engine 814.

Referring to FIG. 9, a table is shown that represents the resource database 900 that may be stored at the platform 800 according to some embodiments. The table may include, for example, entries identifying employees who work for a business. The table may also define fields 902, 904, 906, 908, 910 for each of the entries. The fields 902, 904, 906, 908, 910 may, according to some embodiments, specify: an employee identifier 902, an employee name 904, an essential flag 906, a salary 908, and a date of hire 910. The resource database 900 may be periodically created and updated, for example, based on information electrically received from a Human Resources (“HR”) department.

The employee identifier 902 might be, for example, a unique alphanumeric code identifying a person who works for a business or other enterprise. The employee name 904 might identify the person and the essential flag 906 might indicate if the personal qualifies as “essential personnel.” Note that in some embodiments, all employees are considered “essential personnel” (except for part-time workers and independent contractors). The salary 908 might indicate his or her yearly income and the data of hire 910 might indicate how long the employee has worked for the business.

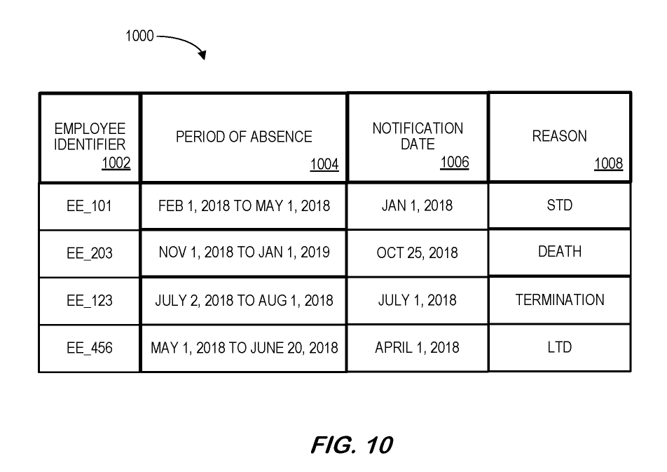

Referring to FIG. 10, a table is shown that represents the resource interruption database 1000 that may be stored at the platform 800 according to some embodiments. The table may include, for example, entries identifying employees who have been absent from work. The table may also define fields 1002, 1004, 1006, 1008 for each of the entries. The fields 1002, 1004, 1006, 1008 may, according to some embodiments, specify: an employee identifier 1002, a period of absence 1004, a notification date 1006, and a reason 1008. The resource interruption database 1000 may be periodically created and updated, for example, based on information electrically received from a Human Resources (“HR”) department or an insurance claim.

The employee identifier 1002 might be, for example, a unique alphanumeric code identifying a person who works for a business and may be based on, or associated with, the employee identifier 902 in the resource database 900. The period of absence 1004 might indicate when that employee was absent from work. The notification date 1006 might indicate when the business or enterprise was notified that the employee was going to be absent. The reason 1008 might indicate why the employee was not at work (e.g., he or she was fired, retired, etc.). The period of absence 1004, notification date 1006, and reason 1008 might be used, for example, to determine if a qualified insurance event was triggered.

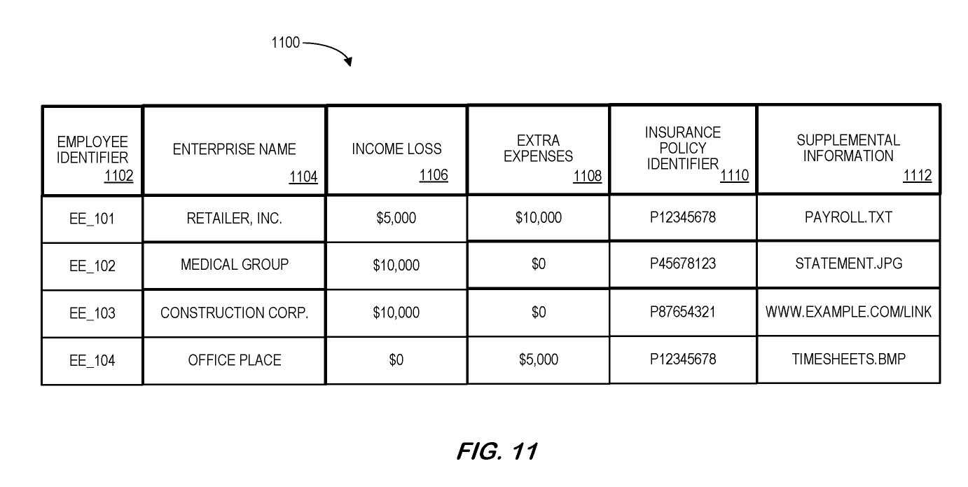

Referring to FIG. 11, a table is shown that represents the resource impact database 1100 that may be stored at the platform 800 according to some embodiments. The table may include, for example, entries identifying a magnitude of impact that resulted from employees being absent from work. The table may also define fields 1102, 1104, 1106, 1108, 1110, 1112 for each of the entries. The fields 1102, 1104, 1106, 1108, 1110, 1112 may, according to some embodiments, specify: an employee identifier 1102, an enterprise name 1104, income loss 1106, extra expenses 1108, an insurance policy identifier 1110, and supplemental information 1112. The resource impact database 1100 may be periodically created and updated, for example, based on information electrically received in connection with insurance claims.

The employee identifier 1102 might be, for example, a unique alphanumeric code identifying a person who works for a business and may be based on, or associated with the employee identifier 902 in the resource database 900. The enterprise name 1104 might identify the business who employees the employee. The income loss 1106 and extra expenses 1108 may indicate, for example, amounts of loss that may be associated with any of the embodiments described herein. The insurance policy identifier 1110 might indicate the policy number associated with an insurance claims (e.g., to be used to determine a coverage limit associated with that policy). Note that the resource impact database 1100 may also store electronic copies of evidence support in the insurance claim (e.g., payroll records, timesheets, receipts, etc.). For example, the supplemental information 1112 might represent data associated with a sworn statement, payroll record data, timekeeping records, workers' compensation or disability claim payment information, correspondence between the business and an employee, an indication of a news report associated with an employee, an indication of an obituary associated with an employee, and/or social media information associated with an employee. According to some embodiments, the supplemental information 1112 might comprise a link to external information (e.g., a link to third-party data). Note that the supplemental information might be associated with various types of data including text information, image information, and/or video information (e.g., a video statement submitted by a store manager).

Thus, embodiments may provide an automated and efficient way to facilitate allocation of resource interruption risk for an enterprise. The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Some embodiments have been described herein as being associated with particular types of business. Note, however, that embodiments may be associated with other types of businesses. For example, service industry businesses, retailers, medical service providers, etc. might all be associated with any of the embodiments described herein.

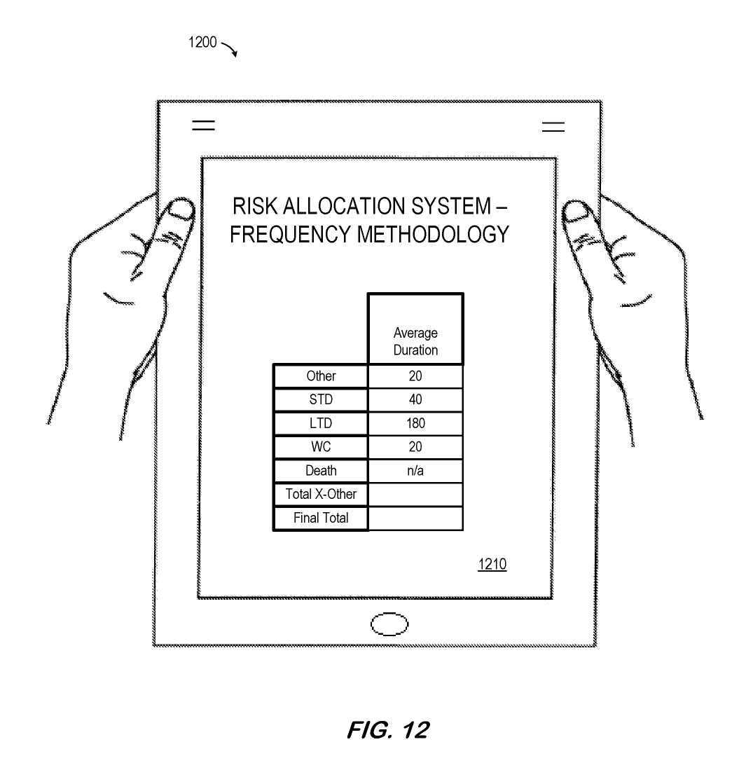

Although specific hardware and data configurations have been described herein, note that any number of other configurations may be provided in accordance with embodiments of the present invention (e.g., some of the information associated with employee records might be implemented as an augmented reality display and/or the databases described herein may be combined or stored in external systems). Still further, the displays and devices illustrated herein are only provided as examples, and embodiments may be associated with any other types of user interfaces. For example, FIG. 12 illustrates a handheld tablet computer display 1200 should risk allocation system frequency methodology data 1210 according to some embodiments. In this way, a user might access a touchscreen to request and/or adjust data in connection with a back-end application computer server.

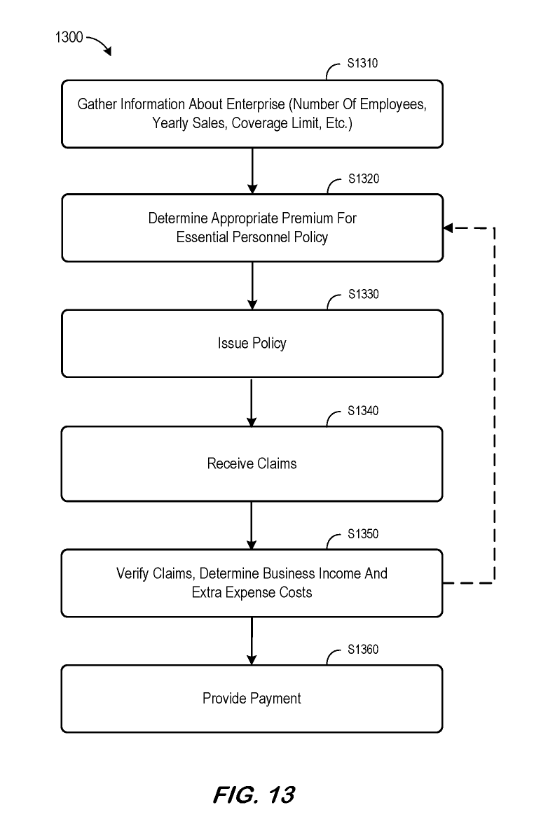

FIG. 13 illustrates an overall enterprise method 1300 that might be performed in accordance with some embodiments. At S1310, an insurer may gather information about an enterprise. For example, the insurer might determine a number of employees who work for a business, an annual amount of sales associated with the business, a desired coverage amount, etc. At S1320, the insurer may determine an appropriate insurance premium for an essential personnel insurance policy in accordance with any of the embodiments described herein. At S1330, the insurer may issue the policy to the business and eventually receive one or more insurance claims at S1340. At S1350, the insurer may verify the claims (e.g., where the appropriate trigger conditions satisfied?) and determine business income and extra expense costs. According to some embodiments, this information may be feed back to the underwriting process of S1320 (e.g., to improve future premium pricing decisions as illustrated by the dashed line of FIG. 13). At S1360, the insurer may provide payment to the business in connection with the insurance policy.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A system to process data allocating resource interruption risk for an enterprise via a back-end application computer server, comprising:
a resource interruption data store containing electronic data records associated with the enterprise, each electronic data record being associated with an unexpected resource interruption having a resource identifier, a notification indication, and data defining a period of time that the resource is not available to the enterprise;
a resource impact data store containing electronic data records associated with the enterprise, each electronic data record being associated with an enterprise impact and including a resource identifier, an impact value reflecting a magnitude of the impact to the enterprise, and supplemental information associated with the enterprise impact; and
the back-end application computer server, coupled to the resource interruption data store and the resource impact data store, to receive input from remote user terminals via a distributed communication network, the back-end application computer server including a computer processor programmed to:
(i) responsive to a request received from a remote user terminal, apply logic to automatically identify a period of time that a particular resource, associated with a particular resource identifier, is unexpectedly not available to the enterprise, the identification being based at least in part on a waiting period and the notification indication associated with the particular resource identifier,
(ii) automatically calculate an overall amount associated with the enterprise based at least in part on the automatically identified period of time, the supplemental information, and the impact value associated with the particular resource identifier along with a pre-defined threshold associated with the enterprise, and
(iii) automatically transmit information associated with the calculated overall amount to the remote user terminal that generated the request.

2. The system of claim 1, further comprising:
a resource data store containing electronic data records associated with the enterprise, each electronic data record being associated with a resource having a resource identifier and a resource importance flag.

3. The system of claim 1, wherein a risk relationship is established with the enterprise in exchange for receiving a payment.

4. The system of claim 3, wherein the enterprise comprises a business, the risk relationship is associated with an insurance policy, and the payment is associated with an insurance premium.

5. The system of claim 4, wherein the back-end application computer server is further to calculate an appropriate insurance premium for the insurance policy.

6. The system of claim 5, wherein the appropriate insurance premium is based at least in part on at least four of: (i) a coverage limit, (ii) a number of employees, (iii) a business sales amount, (iv) an industry category, (v) a frequency component, (vi) a severity component, (vii) a permissible component, (viii) a base rate, (ix) a size curve, (x) disability claim history, (xi) workers' compensation claim history, (xii) a mortality rate, (xiii) a frequency distribution, (xiv) a correlation of risk, and (xv) at least one loss mitigation factor.

7. The system of claim 4, wherein the resource identifier is associated with an employee of the business.

8. The system of claim 4, wherein the supplemental information comprises electronic evidence including at least one of: (i) data associated with a sworn statement, (ii) payroll record data, (iii) timekeeping records, (iv) workers' compensation or disability claim payment information, (v) correspondence between the business and an employee, (vi) an indication of a news report associated with an employee, (vii) an indication of an obituary associated with an employee, (viii) social media information associated with an employee, (ix) a link to external information, (x) text information, (xi) image information, and (xii) video information.

9. The system of claim 4, wherein the overall amount includes both a lost business income component and an extra business expense component.

10. A computerized method to process data allocating resource interruption risk for an enterprise via a back-end application computer server, comprising:
accessing, by a back-end application computer server, a resource interruption data store containing electronic data records associated with the enterprise, each electronic data record being associated with an unexpected resource interruption having a resource identifier, a notification indication, and data defining a period of time that the resource is not available to the enterprise;
accessing, by the back-end application computer server, a resource impact data store containing electronic data records associated with the enterprise, each electronic data record being associated with an enterprise impact and including a resource identifier, an impact value reflecting a magnitude of the impact to the enterprise, and supplemental information associated with the enterprise impact;
responsive to a request received from a remote user terminal via a distributed communication network, applying logic to automatically identify a period of time that a particular resource, associated with a particular resource identifier, is unexpectedly not available to the enterprise, the identification being based at least in part on a waiting period and the notification indication associated with the particular resource identifier;
calculating an overall amount associated with the enterprise based at least in part on the automatically identified period of time, the supplemental information, and the impact value associated with the particular resource identifier along with a pre-defined threshold associated with the enterprise; and
transmitting, via the distributed communication network, information associated with the calculated overall amount to the remote user terminal that generated the request.

11. The method of claim 10, wherein a risk relationship is established with the enterprise in exchange for receiving a payment.

12. The method of claim 11, wherein the enterprise comprises a business, the risk relationship is associated with an insurance policy, and the payment is associated with an insurance premium.

13. The method of claim 12, wherein the back-end application computer server is further to calculate an appropriate insurance premium for the insurance policy.

14. The method of claim 13, wherein the appropriate insurance premium is based at least in part on at least four of: (i) a coverage limit, (ii) a number of employees, (iii) a business sales amount, (iv) an industry category, (v) a frequency component, (vi) a severity component, (vii) a permissible component, (viii) a base rate, (ix) a size curve, (x) disability claim history, (xi) workers' compensation claim history, (xii) a mortality rate, (xiii) a frequency distribution, (xiv) a correlation of risk, and (xv) at least one loss mitigation factor.

15. The method of claim 12, wherein the resource identifier is associated with an employee of the business.

16. The method of claim 12, wherein the supplemental information comprises electronic evidence including at least one of: (i) data associated with a sworn statement, (ii) payroll record data, (iii) timekeeping records, (iv) workers' compensation or disability claim payment information, (v) correspondence between the business and an employee, (vi) an indication of a news report associated with an employee, (vii) an indication of an obituary associated with an employee, (viii) social media information associated with an employee, (ix) a link to external information, (x) text information, (xi) image information, and (xii) video information.

17. The method of claim 12, wherein the overall amount includes both a lost business income component and an extra business expense component.

18. A system to process data allocating risk associated with loss of essential personnel for a business via a back-end application computer server, comprising:
a loss of employee data store containing electronic data records associated with the business, each electronic data record being associated with an unexpected loss of an employee having an employee identifier, a notification indication, and data defining a period of time that the employee is not available to the business;
a covered loss data store containing electronic data records associated with the business, each electronic data record being associated with business impact and including an employee identifier, a business income loss, an extra expense cost, and electronic supplemental evidence supporting the business impact; and
the back-end application computer server to receive input from remote user terminals via a distributed communication network, the back-end application computer server including a computer processor programmed to:
(i) responsive to a request received from a remote user terminal, apply logic to automatically identify a period of time that a particular employee, associated with a particular employee identifier, is unexpectedly not available to the business, the identification being based at least in part on indication waiting period and the notification indication associated with the particular employee identifier,
(ii) automatically calculate an overall amount associated with the business based at least in part on the automatically identified period of time, the business income loss, the extra expense cost associated with the particular employee identifier, and the electronic supplemental evidence along with a pre-defined coverage limit associated with the business, and
(iii) automatically transmit information associated with the calculated overall amount to the remote user terminal that generated the request.

19. The system of claim 18, wherein an insurance policy is established with the business in exchange for receiving payment of an insurance premium, and the back-end application computer server is further to calculate an appropriate insurance premium for the insurance policy based at least in part on at least four of: (i) a coverage limit, (ii) a number of employees, (iii) a business sales amount, (iv) an industry category, (v) a frequency component, (vi) a severity component, (vii) a permissible component, (viii) a base rate, (ix) a size curve, (x) disability claim history, (xi) workers' compensation claim history, (xii) a mortality rate, (xiii) a frequency distribution, (xiv) a correlation of risk, and (xv) at least one loss mitigation factor.

20. The system of claim 18, wherein the electronic supplemental evidence includes at least two of: (i) data associated with a sworn statement, (ii) payroll record data, (iii) timekeeping records, (iv) workers' compensation or disability claim payment information, (v) correspondence between the business and an employee, (vi) an indication of a news report associated with an employee, (vii) an indication of an obituary associated with an employee, and (viii) social media information associated with an employee, (ix) a link to external information, (x) text information, (xi) image information, and (xii) video information.
